(19) United States
(12) Patent Application Publication
(10) Pub. No.: US 2009/0022076 A1
(43) Pub. Date: Jan. 22, 2009

(54) NETWORK TYPE ASSISTED WLAN NETWORK SELECTION

(76) Inventors: Necati Canpolat, Beaverton, OR (US); Vivek Gupta, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/778,651

(22) Filed: Jul. 17, 2007

(51) Int. Cl. H04B 7/00

(52) U.S. Cl. 370/310

(57) ABSTRACT

A device to request and receive a packet of information that details WLAN network information prior to association with the WLAN. This network information about the WLAN allows the device to complete automated network selection and enrollment.

WLAN enabled devices presently rely on user intervention to achieve WLAN hotspot network selection and enrollment to allow access to the network. Improved circuits and methods are needed to address the issues currently faced in WLAN network detection and selection and to increase the efficiency with enrollment.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram that illustrates a wireless device with network type and access to configuration information that provides Wireless Local Area Network (WLAN) network details and query information in accordance with the present invention;

FIG. 2 illustrates embodiments of a WLAN where various wireless communications devices with access to WLAN configuration information may be employed;

FIGS. 3-6 illustrate storage locations that maintain configuration information for WLAN network details to provide query information in accordance with the present invention; and

FIG. 7 is a table that depicts different situations and cases in which the network type and online enrollment information stored in the registers may be used to assist the STA to a correct decision on an appropriate network selection.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

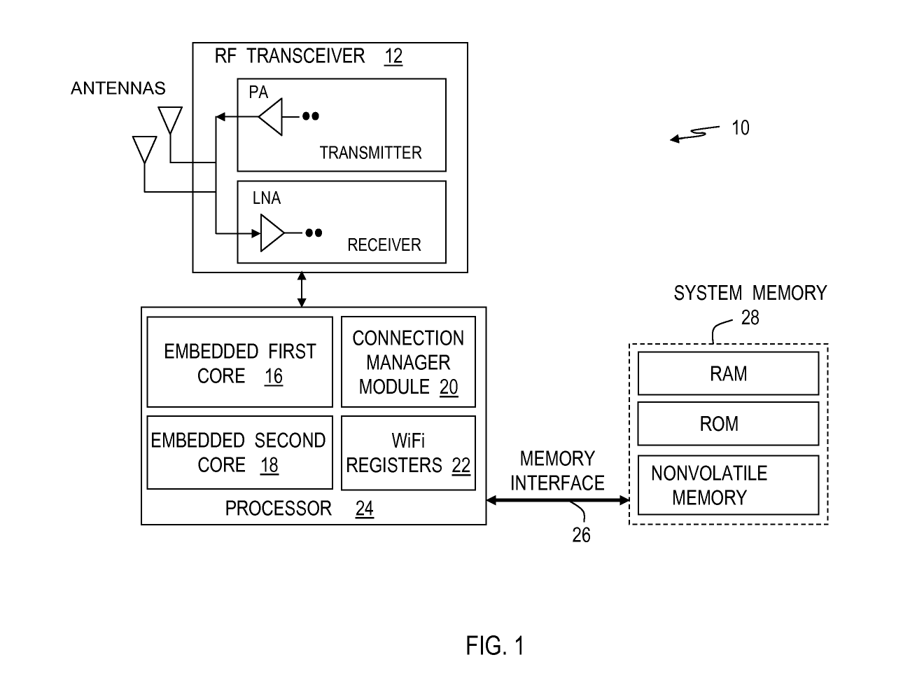

The embodiment illustrated in FIG. 1 shows a wireless communications device 10 that includes one or more radios to allow communication with other over-the-air communication devices. Communications device 10 may operate in wireless networks such as, for example, Wireless Fidelity (Wi-Fi) that provides the underlying technology of Wireless Local Area Network (WLAN) based on the IEEE 802.11 specifications, WiMax and Mobile WiMax based on IEEE 802.16-2005, Wideband Code Division Multiple Access (WCDMA), and Global System for Mobile Communications (GSM) networks, although the present invention is not limited to operate in only these networks. The radio subsystems co-located in the same platform of communications device 10 provide the capability of communicating in an RF/location space with the other devices in the network.

The simplistic embodiment illustrates the coupling of antenna(s) to the transceiver 12 to accommodate modulation/demodulation. Analog transceiver 12 may be embedded with a processor 24 as a mixed-mode integrated circuit where the processor processes functions that fetch instructions, generate decodes, find operands, and perform appropriate actions, then stores results. The processor may include baseband and applications processing functions and utilize processor cores 16 and 18 or even more cores to handle application functions and allow processing workloads to be shared across the cores. The processor may transfer data through an interface 26 to memory storage in a system memory 28.

In the presence of WiFi networks wireless communications device 10 may operate as a STA (mobile device with WLAN access) to gain access to a private network or to a commercial network with free public access or access based on a fee that may require roaming agreements to be in place. WiFi networks may be present in a variety of locations such as airports, hotels, coffee shops, etc., to provide WLAN access.

Before being granted WLAN access, security standards may be used to determine whether access to the network is secure. The WiFi Alliance provides security standards such as the Wired Equivalent Privacy (WEP) standard and the WiFi Protective Access (WPA) for WiFi-compatible products. WEP security technology uses fixed keys, whereas the WPA standard uses Temporal Key Integrity Protocol (TKIP) to generate new keys for every 10K of data transmitted over the network. When security is enabled, the STA needs the proper credentials to access the network. Should security features be currently disabled, the STA has open access to the network and may respond according to the network access configuration.

When attempting a WLAN access, the STA cannot tell in advance the type of network such as hotspot, public, private, etc. and further can not know if access is free or fee based. In current products as presently defined, the STA may scan to determine local vicinity of WLAN networks and generate a list of WLANs based on Service Set Identifiers (SSIDs), a sequence of characters that uniquely names a wireless LAN and differentiates one WLAN from another. To participate in the wireless LAN all devices use the same SSID as that of the wireless LAN.

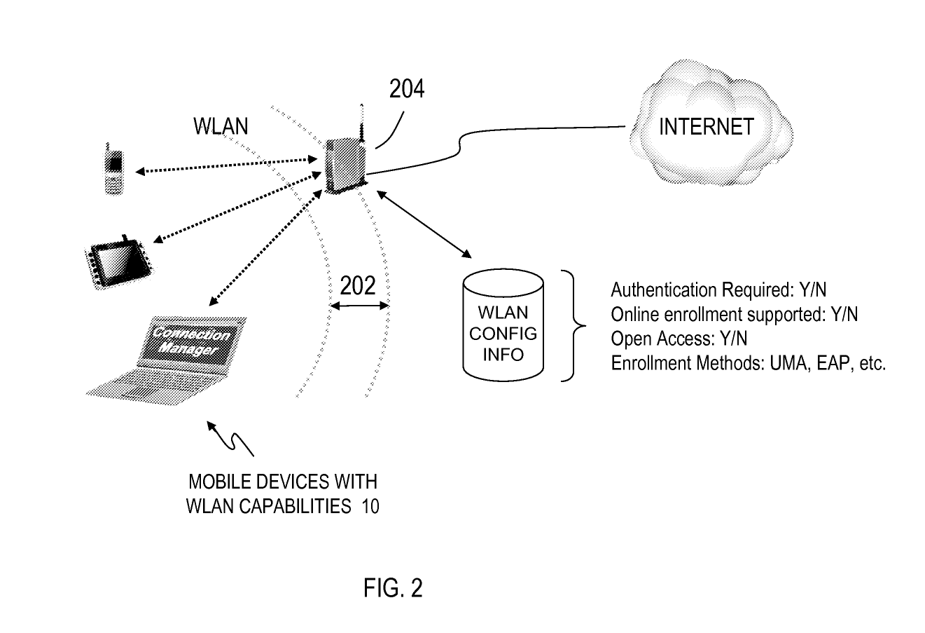

FIG. 2 illustrates a WLAN where wireless communications device 10 may be employed to operate as various wireless products. As shown in the figure, any of the wireless communications devices may attempt to access the WLAN network to determine configuration information such as, for example, type of network, authentication requirements; support for online enrollment; a determination of open access or an access charge; and the preferred enrollment methods for Unlicensed Mobile Alliance (UMA) access and Extensible Authentication Protocol (EAP). EAP is used to pass authentication information between the wireless device and the authentication server, with the actual authentication defined and handled by the EAP type. In the figure, WLAN network 202 is the WLAN access provider such as enterprise, home or the advertised hotspot network. WLAN configuration information is stored in the information server 204 and provides WLAN network details and query information.

Present products, in the absence of an explicit solution to detect the WLAN network type and determine if it is fee based or free access, may employ an Internet session hijacking solution. As the user attempts to access the network using the Internet browser, the initial communication may be intercepted by an Access Point (AP) that presents an access contract to the user that indicates access payments. A Connection Manager entity may see the list of available WLANs and select a preferred WLAN for connection. After selection, the STA is associated with the AP. However, a problem may develop in that even though the STA appears to be connected to the WLAN, the network enrollment process has not yet completed and network access service is not enabled. Thus, the STA appears to be connected but without a completed enrollment, network access services are not enabled and access to email is denied and the VPN fails.

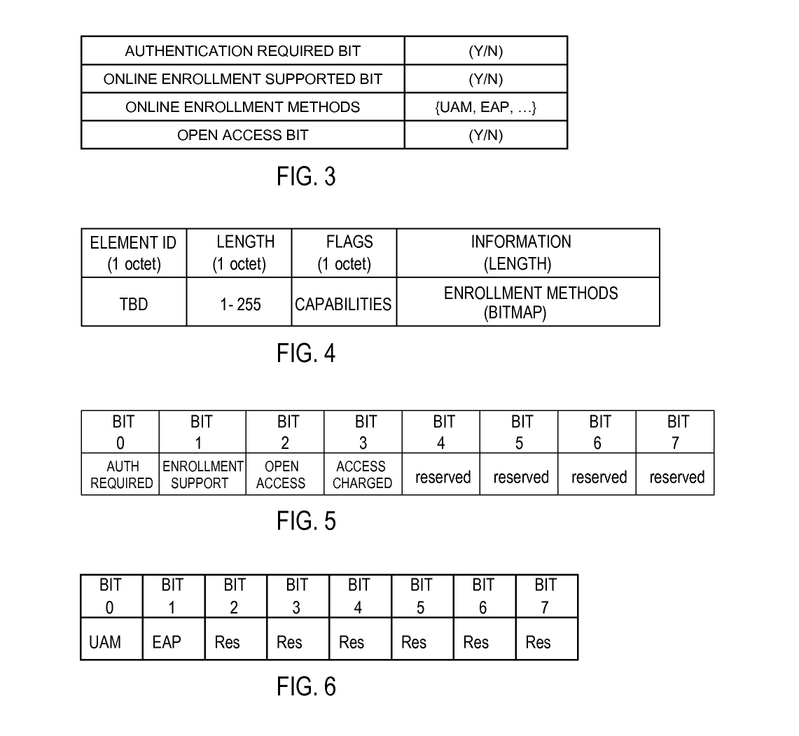

To resolve network selection issues for WLAN enabled devices and facilitate the network enrollment process, the present invention incorporates additional information in the WLAN network configuration. In accordance with the present invention, the WLAN network selection and enrollment process is enhanced by implementing the additional configuration data fields as described in the registers shown in FIGS. 3, 4, 5 and 6.

Specifically, FIG. 3 shows an online enrollment Information Element (IE) that includes information that pertains to the online enrollment capabilities and the supported online enrollment methods for that particular access network. The IE includes information such as: authentication required bit (Y/N); online enrollment supported bit (Y/N); online enrollment methods (UAM, EAP, . . . ); open access bit (Y/N); and next step required to complete the access (Y/N).

FIG. 4 shows an online enrollment IE where four bits of information are defined in support of the online enrollment cluster. FIG. 5 shows the online enrollment Capability Bits that provide status of authentication requirements (BIT 0); enrollment support (BIT 1); open access (BIT 2); and access charged (BIT 3). FIG. 6 shows the online enrollment Information Bitmap that contains a list of supported online enrollment methods such as, for example, UAM, EAP, among others. Note that the present invention illustrated and defined in FIGS. 3, 4, 5 and 6 is not limited by the order of bits, the placement of stored bits, or the number of bits. Accordingly, other embodiments of registers may show modified bit placements in presenting the configuration data without limiting the present invention.

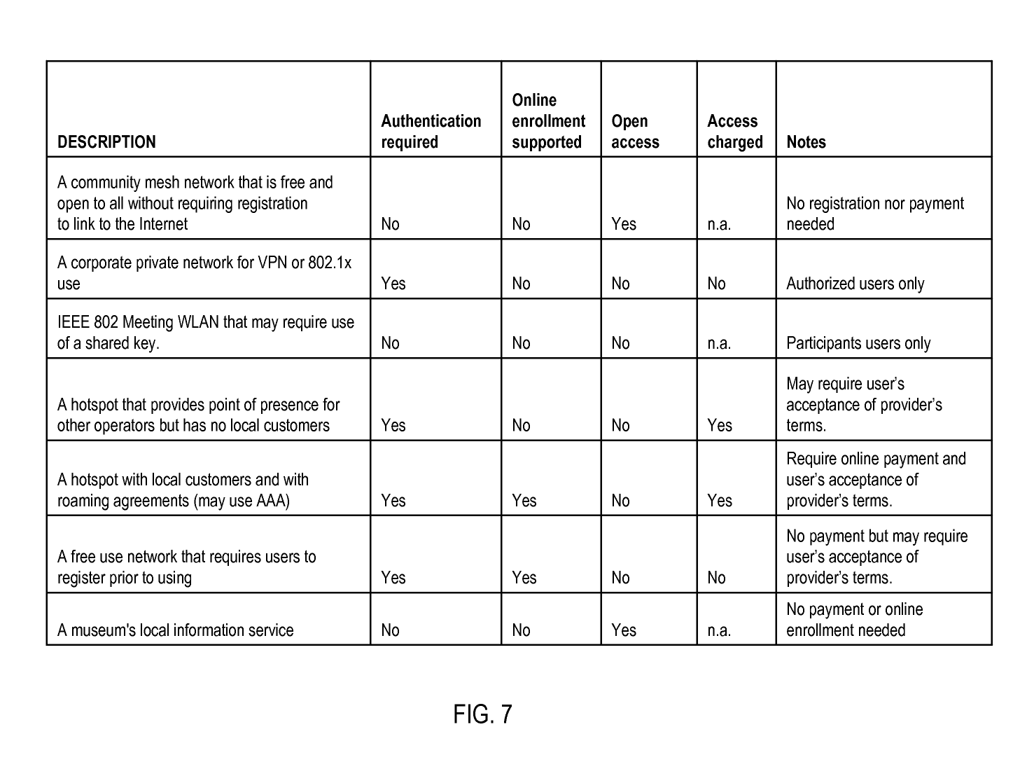

FIG. 7 is a table that describes different situations and cases in which the online enrollment information stored in the registers and described in FIGS. 3, 4, 5 and 6 may be used to assist the STA to a correct decision on an appropriate network selection. The different cases indicate requirements for authentication, online enrollment support, open access or charged access.

Briefly referring to FIG. 1, the STA includes a Connection Manager (CM) module 20 to handle the connectivity of the wireless communications device 10 to the WLAN. Although connection manager module 20 is illustrated as being separate from the processor cores, it should be understood that the functionality provided by this module may be performed within one or more cores. Connection manager module 20 provides the STA with the ability to query for network details that are stored as WLAN configuration information. The configuration information may be stored in a standalone server that is remotely located, or alternatively, the configuration information may be stored in a component running on the WLAN AP. Thus, the stored configuration information is used to identify access details of the target WLAN to facilitate connectivity. The configuration information is arranged to provide specifics on the type of network, i.e. network/public/enterprise/private access and may be provided to users and to upper layer applications in the system. The configuration information also provides information as to whether the access is free, fee based, and the cost associated in providing access. Connection Manager module 20 may also prompt the user for network enrollment, access authorization, and payment.

In operation, the WLAN network characteristics information may be queried by the STA as needed. The network configuration information is readily available and data such as WLAN network type, authorization requirements, enrollment method, access charges, and acceptance of terms are easily accessed. The STA can listen to the network characteristics information prior to WLAN association and make informed decisions as to whether to connect and access the network.

After the network is selected and the STA establishes the association with WLAN, the network configuration information may be used by the Connection Manager (CM) module 20 to launch an Internet browser or some other application to automatically help users with completion of enrollment or acceptance of terms, etc. In this manner the user would establish a WLAN connection and be able to explicitly launch an Internet browser and sign up for service, and email access, etc.

Connection Manager (CM) module 20 in the STA makes use of the network configuration information when making network selections and provides that information to other interested parties. After Connection Manager (CM) module 20 detects that the WLAN is a network, the proper steps to establish network connection and enrollment may be taken. In one embodiment the details of the network may be displayed to allow the user to make connection decisions.

By now it should be apparent that embodiments of the present invention allow the STA to request and receive packet information that details WLAN network type and enrolment information prior to association with the WLAN. With this specific information about the WLAN, the STA may decide to perform the necessary network selection and enrollment steps. The present invention provides mechanisms for making the pre-association WLAN network information available for the STA to use to decide network selection and complete automated network selection and enrollment. Without the present algorithm the STA may appear to be connected to the WLAN but the network enrollment process may not be complete, and therefore, the network access service may not be enabled.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A device to operate in a Wireless Local Area Network (WLAN), comprising:
a transceiver to transmit data packets that query configuration information about the WLAN; and
a connection manager to analyze details about the WLAN received in response to the query that determine pre-association WLAN decisions to automate network selection in the device.

2. The device of claim 1 wherein the configuration information received by the device in response to the query includes authentication requirements for the device to join the WLAN.

3. The device of claim 1 wherein the configuration information received by the device in response to the query includes information of open access or an access charge for the device to join the WLAN.

4. The device of claim 1 wherein the configuration information received by the device in response to the query includes network type and support for online enrollment for the device to join the WLAN.

5. The device of claim 1 wherein the configuration information received by the device in response to the query includes preferred enrollment methods for Unlicensed Mobile Alliance (UMA) access and Extensible Authentication Protocol (EAP).

6. The device of claim 1 wherein the connection manager executes network selection based on user preferences.

7. A Wireless Local Area Network (WLAN) device, comprising:
a transceiver to receive and transmit data packets; and
a processor coupled to the transceiver to issue a query request that elicits a received response of stored configuration information having details about a WLAN that the processor uses to make pre-association WLAN decisions about selecting and joining the WLAN.

8. The WLAN device of claim 7 wherein a Connection Manager (CM) module in the WLAN device detects a type of WLAN network.

9. The WLAN device of claim 8 wherein the CM module in the WLAN device uses the configuration information to establish network selection and enrollment.

10. The WLAN device of claim 8 wherein the CM module in the WLAN device makes the configuration information available to other users.

11. The WLAN device of claim 8 wherein the CM module in the WLAN device makes network type configuration information available for display by the device to allow a user to make connection decisions or the network type configuration information is programmatically handled within the WLAN device.

12. The WLAN device of claim 8 further comprising:
a network type and online enrollment Information Element (IE) that includes information that pertains to the network type and supported online enrollment methods for a network.

13. A WLAN connecting first and second devices, comprising:
dual antenna;
a transceiver in the first device coupled to the dual antenna to query for WLAN network characteristics information; and
a storage memory in the second device accessible to provide configuration information about WLAN network type and enrollment information in response to the query that allows the first device to make pre-association WLAN decisions to automate network selection in the first device.

14. The WLAN of claim 13 wherein the first device listens to the WLAN network characteristics information prior to WLAN association to make informed decisions as to whether to connect to the network.

15. The WLAN of claim 13 wherein the storage memory maintains network type bits that provide the WLAN network type including public WLAN and private WLAN.

16. The WLAN of claim 13 wherein the storage memory maintains online enrollment capability bits that provide status of authentication requirements.

17. The WLAN of claim 13 wherein the storage memory maintains online enrollment capability bits that provide status of enrollment support.

18. The WLAN of claim 13 wherein the storage memory maintains online enrollment capability bits that provide status of open access or fee-based access.

19. The WLAN of claim 13 wherein the storage memory maintains an online enrollment information bitmap that contains a list of supported online enrollment methods UAM and EAP.
